(19) United States
(12) Patent Application Publication
(10) Pub. No.: US 2005/0220125 A1
(43) Pub. Date: Oct. 6, 2005

(54) Method of transmitting data between nodes of multiple access communications network by decrementing an associated counter

(75) Inventors: Emmanuel Dotaro, Verrieres Le Buisson (FR); Nicolas Le Sauze, Bures-Sur-Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/073,568

(22) Filed: Mar. 8, 2005

(30) Foreign Application Priority Data
Mar. 9, 2004 (FR) 04 50 470

(51) Int. Cl. H04L 12/56; H04L 1/00; H04J 14/00; H04B 10/20; H04J 3/14; H04J 1/16; H04L 12/26; H04L 12/28

(52) U.S. Cl. 370/400; 370/235

(57) ABSTRACT

A method is dedicated to transmitting data between nodes (Ni) of a group of nodes coupled to an access bus (L2-LSP) of a communications network (R1). The method consists in: i) each time an entry node (N2) of said group receives data addressed to at least one other node of said group, determining the number M of nodes (Ni) of that group through which the data must pass to reach its destination, including said destination node (N4), and that together define a transmission path starting from said entry node (N2), and then assigning to a dedicated field associated with said data a value representative of the number M before transmitting said data, via said access bus, to a first node (N3) of said path, and ii) at each node (Ni) of said path, decrementing by unity the number associated with the data received to obtain a new value of the field and, in the event of a new value equal to a selected comparison value, dropping said data from said path, and, in the event of a new value different from said selected comparison value, replacing the value of the dedicated field associated with the received data by said new value and then transmitting said data and said new value of the associated dedicated field to the next node of said path.

The invention relates to the field of “multiple access” communications networks and to be more precise to the transmission of data between nodes of such networks. In the present context, the expression “multiple access network” means a network in which one or more structures are defined that have an access bus function (in terms of resources and/or connections) and to which a selected group of its nodes is coupled.

In the present context, the expression “data transmission” refers to any transmission mode, whether that be a “point-to-point” (or “unicast”) mode, a “point-to-multipoint” mode (a “multicast” mode, if the data is intended only for a subgroup of a group of nodes, or a “broadcast” mode if the data is intended for all of the nodes of a group), or a “multipoint-to-multipoint” mode.

The person skilled in the art is aware that the transmission of data between an entry node belonging to a group coupled to one of the access buses of a multiple access communications network and one or more destination nodes belonging to the same group necessitates associating with the data, by stacking:
either connection identifiers, for example MultiProtocol Label Switching (MPLS) labels, for distinguishing, firstly, the multiple access resources (also known as access buses) of the network, by means of an “external” or primary label, then one of the connections between nodes supported by the access bus to which those nodes are coupled, by means of an “internal” or secondary label, or an address field, depending on the technology of the client network;
or MAC addresses of the nodes that define the transmission path between the nodes concerned.

In the first case, to offer connectivity between the N nodes of a group of the network using multiple access resources of the access bus to which they are coupled, it is necessary to define N×(N−1)/2 multiplexed subconnections within the multiple access connection. This imposes processing of the primary label in each node, in order to route the bus, and then processing of the secondary label of each data item of the bus, in order to process each connection. This limits the applications of the point-to-multipoint and multipoint-to-multipoint transmission modes because the control plane remains identical to that used in a packet-switching network, even if the structure of the nodes (i.e. the switching plane) is simplified by switching the buses.

In the second case, a technique known as “destination stripping” must be used. This technique consists in dropping data received at the destination node designated by the associated MAC destination address, in particular in Ethernet networks and in resilient packet ring (RPR) networks. The main drawback of this technique is that it executes in an absolute and level addressing space (i.e. one in which the MAC addresses are absolutely, not relatively, hard-coded and there is no hierarchy). With a technique of this kind, once all the MAC addresses have been assigned to network nodes, no further nodes can be added to said network. Moreover, multicast or broadcast packets must carry a dedicated address to distinguish them from unicast packets, which commensurately further limits addressing possibilities.

An object of the invention is to improve on the above situation.

To this end the invention proposes a method of transmitting data between nodes of a group of nodes coupled to an access bus of a communications network, which method is characterized in that it consists in:
determining, each time an entry node of the group receives data addressed to at least one destination node of the group, the number M of nodes of that group through which the data must pass to reach its destination, including the destination node, and that together define a transmission path starting from the entry node, and then assigning to a dedicated field associated with the data a value representative of a number equal to M before transmitting the data, via the bus, to a first node of the path, and
then, at each node of the path, decrementing by unity the number associated with the data received to obtain a (decremented) new value of the dedicated field and:
in the event of a (decremented) new value equal to a selected comparison value, dropping the data from the path, or
in the event of a new value different from the selected comparison value, replacing the value of the dedicated field associated with the received data by the new value and then transmitting the data and the new (decremented) value of the associated dedicated field to the next node of the path.

The dedicated field is preferably added to the received data in the entry node. Thus this field avoids having two addressing levels in each node; the value of the field therefore replaces secondary addressing (secondary label or client address), leaving only bus addressing (primary label). This economizes on processing in the control plane, in order to obtain the maximum benefit from the point-to-multipoint and multipoint-to-multipoint transmission modes.

The default selected value, to which the new, decremented value is compared, is the lower value, for example. This selected value may also be a value other than zero, however.

Moreover, an additional field may be added to the received data (in packet or frame form) and take a first value indicating transmission in point-to-point mode, a second value indicating transmission in broadcast point-to-multipoint mode, and/or a third value indicating transmission in multicast point-to-multipoint mode. Alternatively, first specific values may be reserved for transmitting the received data in point-to-point (or unicast) mode and second specific values may be reserved for transmitting the received data in broadcast mode. In either case, if the data must be transmitted in broadcast mode, and for as long as the value of the dedicated field is different from the selected comparison value, the data and the associated fields may be duplicated (or copied) at each node of the path in order to drop them and to transmit them after replacing the value of the associated dedicated field with the new value (resulting from the decrementing effected at the node).

When received data (in packet or frame form) must be transmitted in the multicast mode to destination nodes belonging to a subgroup (or domain) of the group, the number M of nodes of the next transmission path that the data must follow to reach the next destination node may be determined again at each destination node. The dedicated field associated with the received data is then assigned a value equal to M, before transmitting the data to the first node of the next path.

In a first variant, the number Mi of nodes of the group defining the transmission path that the data must follow to reach each destination node Ni of the subgroup may be determined, after which the data to be transmitted is associated with a dedicated field for each destination node Ni and a value representative of the number Mi is assigned to each of the dedicated fields, after which the data and the associated dedicated fields are transmitted via the access bus to a first node of the path, after which, at each node of the path, the value of each dedicated field associated with the received data is decremented by unity to obtain new values, and in the event of a new value equal to the selected comparison value (for example zero) the data and the associated fields are duplicated (or copied) in order to drop them and to transmit them after replacing the values of the associated dedicated fields with the new values.

In a variant of this first variant, the value (Mi) of each field associated with a destination node Ni represents the number of hops after the node Ni−1. In this case, only the first field (Mi) is decremented in a node Ni and, when its value reaches zero, the frame is duplicated (or copied) in order to drop it and to transmit the copy, minus this first field (Mi), to the next node Ni+1 of the transmission path identified by the next field (Mi+1), which is now at the top of the stack.

In a second variant, the comparison value selected for dropping a packet locally in a destination node Ni may be configurable. To be more precise, having this selected comparison value vary from one destination node to another within a given subgroup may be envisaged. In fact, the default selected value is preferably zero, but in a multicast situation a particular comparison value may be defined by each node Ni belonging to the subgroup, the initial value M remaining equal to the total number of hops to the last node of the subgroup.

If the network has a circuit-oriented transport layer (for example a G.709 circuit), the data constitutes packets that are grouped into frames. In this case, a dedicated field is associated with each packet of a frame, the determined value of each dedicated field is a function of the destination node at which the packet must be dropped, in each node of the transmission path the value of each dedicated field contained in the received frame is decremented by unity to obtain new values, and in the event of a dedicated field comprising a new value that is zero, the packet associated with that dedicated field is dropped, whereas in the event of a field comprising a new value that is not zero, its value is replaced by the corresponding new value, after which the frame comprising the dedicated fields that are associated with the remaining packets and that comprise the new values is transmitted to the next node of the path.

In this case, the dedicated fields associated with the packets of a frame may be grouped in a control packet in an ordered manner conforming to the order of the packets associated with them in the frame. For example, the control packet may be placed just after the frame header, at the start of the frame portion that is dedicated to payload data contained in the packets. Alternatively, the control packet may be placed at the end of the dedicated frame portion dedicated to payload data contained in the packets. In another variant, the dedicated fields associated with the packets of a frame may be placed in the frame header in an ordered manner conforming to the order of the associated packets in that frame. In all the above situations, dedicated fields of variable or fixed size may be used.

Other features and advantages of the invention will become apparent on reading the following detailed description and examining the appended drawings, in which:

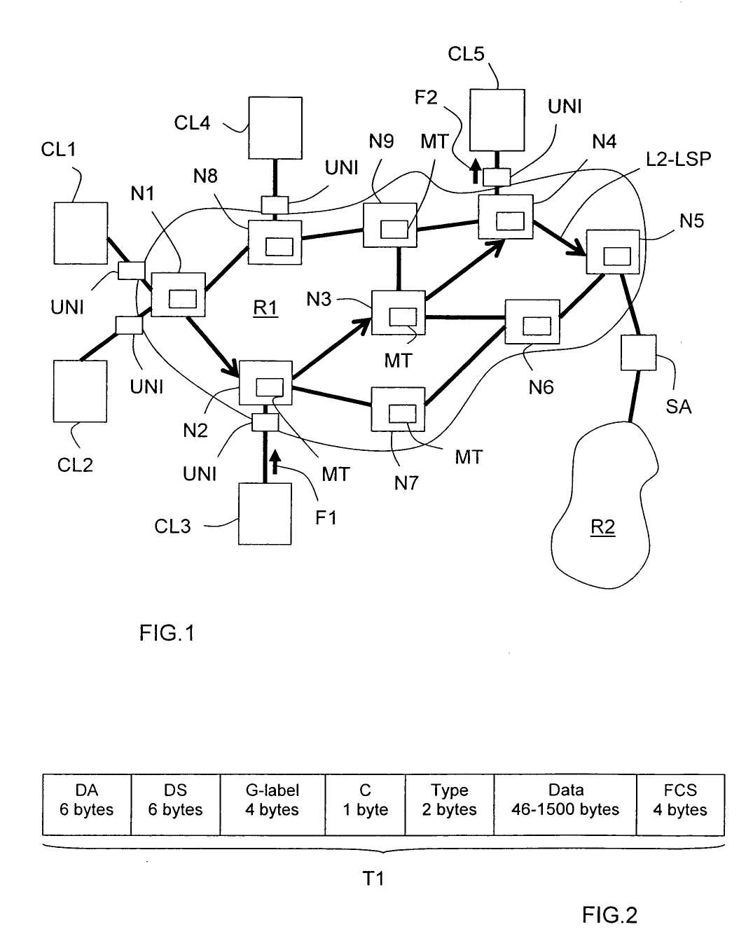

FIG. 1 is a diagram of a first example of a communications network in which a data transmission method of the invention can be used;

FIG. 2 is a diagram of a first example of a frame suitable for implementing the invention in an OSPF routing GMPLS network;

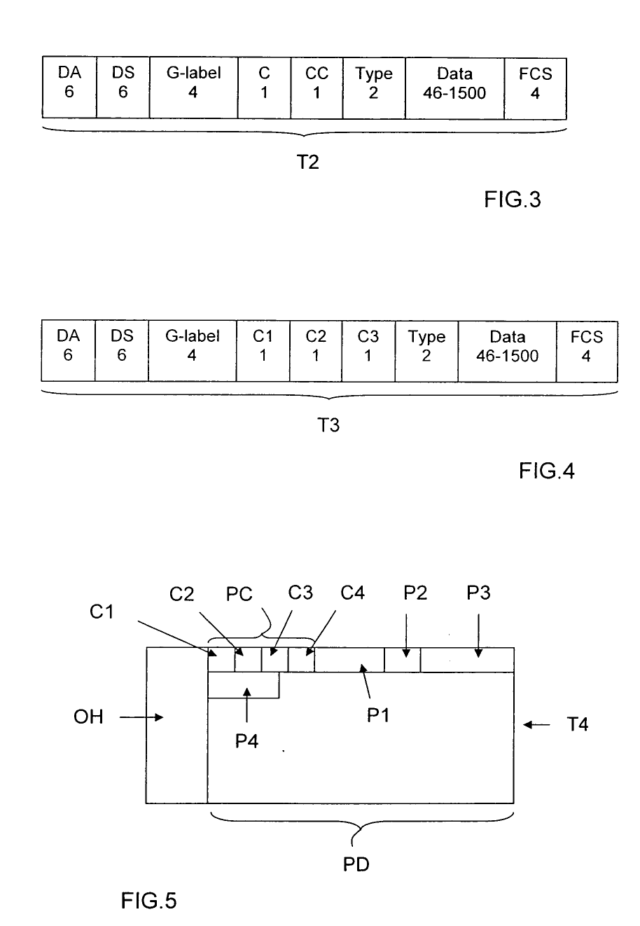

FIG. 3 is a diagram of a second example of a frame suitable for implementing the invention in an OSPF routing GMPLS network;

FIG. 4 is a diagram of a third example of a frame suitable for implementing the invention in an OSPF routing GMPLS network; and

FIG. 5 is a diagram of an example of a frame suitable for implementing the invention in a G.709 circuit-oriented transport layer network.

The appended drawings constitute part of the description of the invention and may contribute to the definition of the invention, if necessary.

An object of the invention is to enable the transmission of data between nodes of a multiple access communications network.

In the present context, the term “multiple access network” means a network in which access bus structures are defined to which selected groups of nodes, the composition of which may vary in time, are respectively coupled.

One example of a communications network R1 in which the invention can be used is described first with reference to FIG. 1.

That network is a Generalized MultiProtocol Label Switching (GMPLS) network and uses an Open Shortest Path First (OSPF) routing protocol, which is an Internet Protocol (IP) family routing algorithm. However, the invention is not limited to this type of network, of course. As will emerge later, it also relates to circuit-oriented transport layer networks, and to G.709 networks in particular, and to all networks using the client layer of any bus resource as a multiple access resource.

The network R1 shown in FIG. 1 conventionally comprises a multiplicity of network equipments constituting nodes Ni; here i=1 to 9, but i may take any value greater than or equal to 2. The nodes Ni are connected together and route data frames between them so that they can be transmitted between one or more source communications terminals (or servers) CLj belonging to a client j, for example, and one or more destination communications terminals (or servers) CLk belonging to another client k, for example.

For example, the nodes Ni are either edge routers connected to one or more client terminals CLⱼ and one or more other routers Ni′ or core routers connected to other peripheral routers and/or core routers.

In the example shown, the node N1 is connected to two client terminals CL1 and CL2, the node N1 is connected to a client terminal CL3, the node N8 is connected to a client terminal CL4, the node N4 is connected to a client terminal CL5, and the node N5 is connected to another network R2, for example a wireless access network (WAN), via an access server SA.

Moreover, in a GMPLS network, virtual circuits or connection(s) called label switched paths (LSPs) are established between certain nodes Ni. These label switched paths are supported on a GMPLS control plane and require a network infrastructure using a (quasi)Level 1 technology in a “TDM-LSP” situation, a (quasi)Level 2 technology in a “Layer 2 LSP (or L2-LSP)) situation, or a (quasi)Level 3 technology in a “packet LSP” situation. In a GMPLS network (R1) each LSP is designated by a label called the GMPLS label (or G-label). Consequently, the label switched paths are switched as a function of the values taken by the G-labels.

In the network R1 of the invention, at least a first LSP level corresponding to the buses that cover the network is defined. Each LSP, referred to as a bus-LSP, is identified by a primary G-label that is used to switch the bus in each node Ni. Thus in reality said bus-LSPs are:
packet-LSPs if the resource granularity is of level 3 (for example an IP packet with an MPLS shim header),
L2-LSPs if the resource granularity is of level 2 (for example an Ethernet frame with a G-label, as represented in FIG. 2), or
TDM-LSPs if the resource granularity is of level 1 (for example a SONET/SDH circuit frame), but with the special feature of being seen by a client layer as a multiple access bus.

The following description refers to a resource granularity of level 2 and therefore to L2-LSP circuits.

A bus can be of the point-to-multipoint type if there is only one sender on it, and then have broadcast connections if all the destination nodes Ni are nodes at which a packet has to be dropped, or multicast connections if a packet has to be dropped at certain destination nodes Ni, but not all of them. A bus can equally be of the multipoint-to-multipoint type if there are a plurality of senders and a plurality of receivers on it.

Moreover, a bus connection can be a point-to-multipoint connection, to enable packets to be transmitted to a plurality of other nodes connected to the bus in broadcast or multicast mode, but cannot be of the multipoint-to-multipoint type, because there is only one sender.

In other words, the multipoint-to-multipoint or point-to-multipoint aspect is operative not at the node (or point) level, but at the bus level.

Data frames coming from a source client terminal CLj access the circuit via a peripheral node Ni and are multiplexed into one of the L2-LSP circuits by interworking functions installed in a user network interface (UNI). Each L2-LSP circuit constitutes an access bus structure to the network R1. If an L2-LSP circuit (or access bus) is defined by N nodes Ni, or in other words if N nodes Ni constituting a group are coupled to the same L2-LSP circuit, N×(N−½) subconnections are defined in that L2-LSP circuit in order to provide connectivity between the N nodes Ni of the group.

The invention proposes a method dedicated to transmitting data between the nodes Ni of a group of nodes coupled to one access bus (here of the L2-LSP type) of a multiple access communications network (here the GMPLS network R1).

This method therefore applies to situations in which an entry (source) node, for example the node N2, coupled to an L2-LSP circuit defined by the nodes N1 to N5, has received (arrow F1) from the client terminal CL3 to which it is connected, via its interface UNI, data to be transmitted (arrow F2) to at least one other client terminal, for example the terminal CL5, connected to a destination node that is also coupled to said L2-LSP circuit, for example the node N4. Consequently, the network R1 is considered to be capable of determining the transmission path (or circuit (portion)) between nodes Ni that the data must take to reach the destination client terminal (here the terminal CL5). Here the transmission path consists of a portion of the L2-LSP circuit defined by the nodes N2, N3 and N4 (shown by broad arrows).

In the situation cited above, the method of the invention first determines the number M of nodes Ni coupled to the L2-LSP circuit concerned which define the transmission path that the data must follow in order to reach the destination node N4, this data coming from the client terminal CL3 and being received by the entry node N2. Here, the nodes defining the transmission path starting from the entry (or source) node N2 are the node N3 (intermediate node) and the node N4 (destination node). Thus in this example M is equal to two (2).

It is important to note that the transmission path is defined here between the first intermediate node (here the node N3), to which the entry node (here the node N2) is connected, and the destination node (here the node N4). However, other definitions of the transmission path may be envisaged, of course. In fact, the path may be considered as defined between the entry node and the destination node. In this case, the number M is one less than the total number of nodes defining the transmission path.

Once the number M has been determined, a dedicated field C associated with the data to be transmitted is assigned a value representative of the number M, before the data and the dedicated field C are transmitted via the L2-LSP access bus to the first (intermediate) node of the transmission path (here the node N3). Unless otherwise indicated, the value assigned to the dedicated field C below is preferably equal to the number M.

This determination is preferably effected at the entry node (here the node N2), by means of a dedicated “interworking” function (IWF) of the user network interface UNI, which also associates with the data to be transmitted the G-label field whose value designates the L2-LSP circuit that the data must take.

In a GMPLS network using an Ethernet transport format, the data to be transmitted is usually integrated into a frame T including a destination terminal address field DA of 6 bytes, a source terminal address field SA of 6 bytes, a G-label field of 4 bytes, a type field of 2 bytes, a data field comprising from 46 to 1500 bytes, and a checksum field FCS of 4 bytes. In a GMPLS network (R1) of the invention, the interface UNI adds to the frame the dedicated field C that initially contains the value M. The GMPLS network of the invention occupies 1 byte, for example. FIG. 2 shows a frame (T1) of this kind by way of example. The order of the fields may vary.

Once the frame T1 has been constituted, it is inserted into the L2-LSP circuit concerned, which conveys it to the first intermediate node (here the node N3) of the transmission path, which is connected to the entry node (here the node N2). The node N3 reads the value M of the dedicated field C (which here is equal to 2) and then decrements that value by unity in order to obtain a new value M′ (which here is equal to 1).

It then compares the new value M′ to zero (0). If M′ is equal to zero (0), it drops the frame T1 from the transmission path, and therefore from the L2-LSP circuit. If M′ is not equal to zero (0), it replaces the value M of the dedicated field C by the new value M′ and then transmits the frame T1 including the new value M′ of the dedicated field C to the next node of the transmission path (here the node N4), again via the L2-LSP circuit.

The dedicated field C may therefore be regarded as a counter which designates the destination node of a frame T1 when its decremented value M′ is equal to zero. This avoids the need to use an address field in each frame T1 to designate its destination node. When a plurality of clients are connected to the same node of the network R1 (such as the node N1), the output interface(s) UNI must sort the dropped packets having a counter M at 0 in order to send them to the correct client CL1 or CL2. This is done in the conventional way by analyzing the client addresses that had remained “hidden” in the network R1.

In the example shown, M′ is equal to 1 and the frame T1 is therefore transmitted to the node N4, with its new value M′.

When the next node (here the node N4) receives the frame T1, it effects the same operations as the preceding node N3, namely reading the value M of the dedicated field C, then decrementing it by unity to obtain the value M′, then comparing the value M′ to the value zero (0), followed by dropping or transmission. If, after decrementing it in this way, the value M′ of the dedicated field C is not equal to zero, the node that has received the frame T1 transmits it to the next node of the L2-LSP circuit to which it is coupled. In the example shown, the decrementing of the value M (equal to 1) of the dedicated field C by the node N4 supplies a new value M′ equal to zero (0). Consequently, the node N4 drops the frame T1 from the L2-LSP circuit in order to transmit it to the client terminal CL3 designated by the address field SA. In other words, here the node N4 is the destination node of the frame T1, even though the frame T1 did not contain an address designating it as such.

It is important to note that, in the above example, the selected comparison value to which the decremented value M′ is compared at a node of the transmission path is equal to zero (0). However, a selected comparison value other than zero may be envisaged. In this case, and in the event of unicast transmission, the initial value of M must be equal to the number of nodes of the transmission path plus a selected value, for example a value equal to the comparison value. It is in this sense that the value of the field C is representative of the number M, and not merely equal to M.

The processing of the frames T1 described above (reading, decrementing, comparing and decision) is preferably effected by a processing module MT of the invention installed in (or connected to) each node Ni of the network R1.

The processing module MT may take the form of electronic circuits, software (or data processing) modules, or a combination of circuits and software. It could even be all-optical, as described in the paper by J. E. McGeehan et al., “All-optical decrementing of packet's Time-To-Live (TTL) field and subsequent dropping of zero-TTL Packet”, Journal of Lightwave Technology, vol. 21, no. 11, November 2003, although not with the aim of avoiding infinite loops in the network (like any IP TTL field), as in the above paper, but rather to enable “routing” of a frame within an LSP bus.

In the situation described above, the frame T1 was transmitted in a point-to-point (unicast) mode. The invention is not limited to this transmission mode alone, however. For example, it may be applied conjointly to point-to-point transmission modes and point-to-multipoint (broadcast and/or multicast) transmission modes.

To this end, an additional (or complementary) field CC may be added to the received frame in the entry node (using its interface UNI), this field taking a first specific value indicating point-to-point mode transmission, a second specific value indicating broadcast mode transmission, or a third specific value indicating multicast mode transmission. FIG. 3 shows a frame T2 of this type by way of example.

When the additional field CC indicates a packet to be transmitted in unicast or broadcast mode, it may consist of a single bit taking the value 0 or 1, for example. In this case it is the combination C+CC that consists of 1 byte (C being defined on 7 bits instead of 8 bits, as before). When the additional field CC indicates a packet to be transmitted in unicast, broadcast or multicast mode, it may consist of 2 bits taking the value 00, 01 or 11, for example.

Alternatively, first specific values for transmitting received data in point-to-point mode and second specific values for transmitting received data in broadcast mode may be reserved in a frame T1.

In either embodiment, when the frame T1 or T2 must be transmitted in broadcast mode, the frame is duplicated (or copied) at each node of the transmission path for as long as the value M′ of the dedicated field C is not zero, in order to drop the copy and transmit the original to the next node, after replacing the value M of the dedicated field C with the new value M′, of course. In other words, in broadcast mode the processing module MT forces the copying and dropping of the frame T1 or T2, even though the value of the dedicated field (or counter) C is not equal to zero.

The invention may equally be applied to the multicast point-to-multipoint transmission mode, in which the frame must be transmitted to a plurality of destination nodes belonging a subgroup (or domain) of the group of nodes defining an L2-LSP circuit.

At least three embodiments enabling this type of transmission may be envisaged.

A first embodiment determines again at each destination node the number M of nodes of the next transmission path that the data must take to reach the next destination node. This is possible because all the nodes that belong to the same domain (or subgroup) are known to each other.

If a node does not have a user network interface UNI, for example because it is a core router, it is preferably its processing module MT that determines the number M of nodes Ni.

Once a new transmission path and the value M of the associated dedicated field C have been determined, at the node constituting both an entry node and a destination node, the received frame is duplicated (or copied) in order to drop it and to transmit the copy to the first node of the next path, after replacing the old value M of the dedicated field C with the new value M, of course.

It is important to note that this first embodiment corresponds more particularly to a situation in which the selected comparison value is zero (0).

A second embodiment first determines the number Mi of nodes of that group that define the transmission path that the frame must follow to reach each destination node Ni of the subgroup (or domain). A dedicated field Ci for each destination node Ni is then added to the received frame at the entry node and a value equal to Mi is assigned to each of the dedicated fields Ci. FIG. 4 shows a frame T3 of this kind by way of example.

The frame T3 is then transmitted to the first node of the transmission path via the L2-LSP access bus concerned. Then, at each node Ni of the transmission path, the value Mi of each dedicated field Ci is decremented by unity to obtain new values M′i; when a new value M′i is zero, the frame T3 is duplicated (or copied) in order to drop it and to transmit the copy to the next node of the transmission path, after replacing the values Mi of the dedicated fields Ci with the new values M′i, of course. Naturally, each time that one of the fields Mi reaches zero (0), that field may optionally be eliminated, in order to “display” the next non-zero value Mi, which represents the number of hops on the bus before the next drop.

Alternatively, at the time of creating the frame T3, each field Mi in the node Ni contains not the number of hops between the source node and the respective destination node, but the number of hops after the node Ni−1. Thus only the first counter Mi in a node is decremented, and when the first counter Mi reaches the value 0, the frame T3 is duplicated (or copied) in order to drop it and to transmit the copy, without this counter Mi, to the next node of the transmission path identified by the new counter Mj that is now on the top of the stack.

It is important to note that this second embodiment corresponds more particularly to a situation in which the selected comparison value is zero (0).

A third embodiment may be envisaged in which the selected comparison value is configurable, and more precisely varies from one destination node to another within a given subgroup.

It is possible in fact to define a particular value Mi for each destination node Ni belonging to a given subgroup. Each value Mi is determined as a function of the position of the destination node Ni on the transmission path. The initial value M is always equal to the total number of hops to the last destination node of the subgroup. To provide an illustrative example, consider the situation in which M=10, the subgroup comprises four destination nodes N1 to N4, and the destination nodes N1, N2, N3 and N4 are respectively at the third, fifth, seventh and tenth positions on the transmission path. In this case, the first node N1 drops data identified as multicast data by the additional field CC and associated with the decremented value M1=7 (the selected comparison value at the node N1 is then equal to 7), the second node N2 drops data identified as multicast data by the additional field CC and associated with the decremented value M2=5 (the selected comparison value at the node N2 is then equal to 5), the third node N3 drops data identified as multicast data by the additional field CC and associated with the decremented value M3=3 (the selected comparison value at the node N3 is then equal to 3), and the fourth and final node N4 of the subgroup drops data associated with the value M4=0 (the selected comparison value at the node N4 is then equal to 0).

As indicated above, the additional field CC can designate a packet to be transmitted in the multicast, broadcast or unicast mode when it consists of 2 bits, for example. However, when it consists of only 1 bit, it can designate only a packet to be transmitted in the broadcast or unicast mode. Another additional field CC′ must then be provided for specifically designating a packet to be transmitted in the multicast mode.

This variant is advantageous because it offers a form of processing that requires only the decrementing of a single field, without having to determine a new value for reaching the next destination node in each new destination node Ni.

An embodiment of the method of the invention in a network R1 with a circuit-oriented transport layer, for example of the G.709 type, is described next with reference to FIG. 5.

In this case, the access buses are G.709 circuits for transporting a plurality of packets or portions of packets, where applicable encapsulated in accordance with selected protocols, which may be different, in frames T4 (see FIG. 5). Moreover, the nodes Ni comprise, firstly, a G.709 frame circuit switch for “routing” G.709 frames to the other nodes of the network and, secondly, modules for adding packets to and dropping packets from frames.

According to the invention, a dedicated field Ci is associated with each packet Pi to be transported by the same frame T4. The initial value Mi of each dedicated field Ci of a frame T4 is determined at the entry node (here the node N2) by the dedicated interworking function (IWF) of its interface UNI and as a function of the destination node Ni at which the corresponding packet Pi must be dropped.

It is important to note that the dedicated fields Ci may be of fixed or variable size.

In the FIG. 5 example, the frame T4 comprises a header (or overhead) OH comprising information and control fields and a portion PD dedicated to payload data containing four packets P1 to P4. Here the four dedicated fields C1 to C4 associated with the four packets P1 to P4 are placed in the portion PD. To be more precise there are grouped together, one after the other, in the same order as the packets P1 to P4, to constitute a control packet (or counter vector) PC. Here the control packet PC is at the beginning of the portion PD, just after the header OH and just before the first packet P1. However, the control packet PC could be placed at the end of the portion PD, just after the last packet P4 in the header OH.

The control packet PC is preferably substituted for G.709 header fields that are no longer of any use.

As in the preceding example, at each node Ni of the transmission path the value Mi of each dedicated field Ci contained in the received frame T4 is decremented by unity to obtain a new value M′i. Each new value M′i is then compared to zero (0). If a dedicated field Ci contains a new value M′i that is zero, the associated value Pi is dropped. Conversely, if a field Ci contains a new value M′I that is not zero, its (received) value Mi is replaced by the corresponding new value M′i. The frame T4 comprises the dedicated fields Ci associated with the remaining packets Pi and containing the new values M′i are then transmitted to the next node on the transmission path. In other words, the dedicated field Ci whose decremented new value M′i is zero is preferably removed from the frame T4 before transmitting it to the next node. Of course, if a new packet, where applicable an encapsulated new packet, must be added to the frame T4 to be transmitted, the field Ci may be used again for that new packet, but with a new value Mi. Moreover, if a plurality of packets Pj, where applicable encapsulated packets, must be added to the frame T4 to be transmitted, they are associated with as many new fields Cj as necessary.

The invention therefore dispenses not only with the G.709 headers but also with the addressing tables needed for processing addresses for packets in transit in prior art networks, since addressing tables are always necessary at the interface UNI for adding and dropping packets. The processing effected at a node is therefore reduced to reading the value Mi of each dedicated field Ci of the received frame, then decrementing each value Mi by unity in order to obtain the new value M′i, then comparing each value M′i to the selected comparison value (for example zero (0)), and finally deciding, in the light of the results of the comparison of the corresponding new value M′i, whether to drop each packet Pi or to transmit it.

It is important to note that the control plane or the management plane of the network may be used to supply the nodes with the designations of the nodes that belong to their own subgroup (or domain). In other words, the definitions of the subgroups of nodes may be varied dynamically. Moreover, it is also possible to vary dynamically the definitions of the various access buses of a network, i.e. the groups of nodes that are coupled to the various access buses, again by means of the control plane or the management plane of the network.

The invention is not limited to the embodiments of the processing module MT, the network node Ni and the transmission method described hereinabove by way of example only, but encompasses all variants that the person skilled in the art might envisage that fall within the scope of the following claims.

1. A method of transmitting data between nodes (Ni) of a group of nodes coupled to an access bus of a communications network (R1), which method is characterized in that it consists in:
i) in the event of reception at an entry node (N2) of said group of data addressed to at least one destination node (N4) of said group, determining the number M of nodes of that group through which the data must pass to reach its destination, including said destination node (N4), and that together define a transmission path starting from said entry node (N2), and then assigning to a dedicated field (C) associated with said data a value representative of a number equal to M before transmitting said data, via said bus, to a first node (N3) of said path, and
ii) at each node (N3, N4) of said path, decrementing by unity the number associated with the data received to obtain a new value of said dedicated field (C) and, in the event of a new value equal to a selected comparison value, dropping said data from said path, and, in the event of a new value different from said selected comparison value, replacing the value of said dedicated field (C) associated with the received data by said new value and then transmitting said data and said new value of the associated dedicated field (C) to the next node of said path.

2. A method according to claim 1, characterized in that the dedicated field is added to said received data in said entry node (N2).

3. A method according to claim 1, characterized in that an additional field (CC) is added to said received data in said entry node (N2) and takes a first value indicating transmission in point-to-point mode, a second value indicating transmission in broadcast point-to-multipoint mode corresponding to transmission to all the destination nodes belonging to said group, and/or a third value indicating transmission in multicast point-to-multipoint mode corresponding to transmission to destination nodes belonging to a subgroup of said group.

4. A method according to claim 1, characterized in that first specific values are reserved for transmission of said received data in point-to-point mode and second specific values are reserved for transmission of said received data in broadcast point-to-multipoint mode corresponding to transmission to all the destination nodes belonging to said group.

5. A method according to claim 3, characterized in that, in the event of transmission of data in broadcast point-to-multipoint mode, and for as long as said value of the dedicated field is different from said selected comparison value, said data and the associated fields are duplicated at each node (Ni) of said path in order to drop them and to transmit them after replacing the value of the associated dedicated field (C) with said new value.

6. A method according to claim 1, characterized in that, in the event of transmission of received data in multicast point-to-multipoint mode corresponding to transmission to destination nodes belonging to a subgroup of said group, the number M of nodes of the next transmission path that said data must follow to reach said next destination node is determined again at each destination node, after which said dedicated field associated with said received data is assigned a value equal to M, before transmitting the data to the first node of said next path.

7. A method according to claim 1, characterized in that, in the event of transmission of received data in multicast point-to-multipoint mode corresponding to transmission to destination nodes belonging to a subgroup of said group:
i) the number (Mi) of nodes of said group defining the transmission path that said data must follow to reach each destination node (Ni) of said subgroup is determined, after which the data to be transmitted is associated with a dedicated field (Ci) for each destination node (Ni) and a value representative of said number (Mi) is assigned to each of said dedicated fields (Ci), after which said data and said associated dedicated fields are transmitted via said bus to a first node of said path, and
ii) at each node of said path, the value of each dedicated field associated with the received data is decremented by unity to obtain new values, and in the event of a new value equal to said selected comparison value said data and the associated fields are duplicated in order to drop them and to transmit them after replacing the values of the associated dedicated fields with said new values.

8. A method according to claim 1, characterized in that, in the event of transmission of received data in multicast point-to-multipoint mode corresponding to transmission to destination nodes belonging to a subgroup of said group,
i) starting from said entry node (N2), the next destination node (Ni) of said subgroup and the number (Ni) of nodes of said group defining the transmission path that said data must follow to reach it are progressively determined, after which said data to be transmitted is associated with a dedicated field (Ci) for each destination node (Ni) and a value representative of said number (Mi) is assigned to each of said dedicated fields (Ci), after which said data and said associated dedicated fields are transmitted via said bus to a first node of said path, and
ii) at each node of said path, the value of the first dedicated field associated with the received data is decremented by unity to obtain a new value, and in the event of a new value equal to said selected comparison value, said data and the associated fields are duplicated in order to drop them and to transmit them after removing the associated dedicated field whose value is equal to said selected comparison value.

9. A method according to claim 1, characterized in that said selected comparison value is equal to zero.

10. A method according to claim 1, characterized in that, in the event of transmission of received data in multicast point-to-multipoint mode corresponding to transmission to destination nodes belonging to a subgroup of said group:
i) a number M of nodes of that group through which the data must pass to reach each destination of said subgroup, including the last one (N4), and that together define a transmission path starting from said entry node (M2), is determined,
ii) after which a comparison value for each of said destination nodes of said subgroup is determined as a function of its position on said transmission path,
iii) after which a dedicated field (C) associated with said data is assigned a value representative of the number M, before transmitting the data via said bus to a first node (N3) of said path, and
iv) in each node of said path, the value of said dedicated field associated with the received data is decremented by unity to obtain a new value, and, in the event of a new value different from said selected comparison value determined for said node, the value of said dedicated field (C) associated with the received data is replaced with said new value, after which said data and said new value of the associated dedicated field (C) are transmitted to the next node of said path, whereas, in the event of a new value equal to the comparison value determined by said node and different from zero, said data and the associated field are duplicated in order to drop them and to transmit them to the next node of said path after replacing the value of the dedicated field associated with said new value, and in the event of a new value equal to zero said data is dropped from said path.

11. A method according to claim 6, characterized in that another additional field (CC′) able to assume a single value indicating transmission in multicast point-to-multipoint mode is added to said received data in said entry node (N2).

12. A method according to claim 1, characterized in that said data constitutes packets.

13. A method according to claim 1, characterized in that in the event of a circuit-oriented transport layer network (R1) in which said data constitutes packets (Pj) grouped in frames:
i) a dedicated field (Cj) is associated with each packet (Pj) of a frame, the determined value of each dedicated field being a function of the destination node at which said packet (Pj) must be dropped, and
ii) in each node (Ni) of said path, the value of each dedicated field (Cj) contained in the received frame is decremented by unity to obtain new values, and in the event of a dedicated field (Cj) containing a new value equal to the selected comparison value, if said comparison value is zero, the packet (Pj) associated with said dedicated field (Cj) is dropped, whereas in the event of a dedicated field (Cj) containing a new value other than zero, its value is replaced by said corresponding new value, after which said frame comprising the dedicated fields (Cj) associated with the remaining packets (Pj) and containing the new values is transmitted to the next node of said path.

14. A method according to claim 13, characterized in that said dedicated fields (Cj) associated with the packets (Pj) of a frame are grouped in an ordered fashion in a control packet (PC) according to the order of the associated packets (Pj) in said frame.

15. A method according to claim 14, characterized in that said control packet (PC) is placed just after the frame header (OH), at the beginning of the frame portion (PD) dedicated to payload data contained in said packets (Pj).

16. A method according to claim 14, characterized in that said control packet (PC) is placed at the end of the frame portion (PD) dedicated to payload data contained in said packets (Pj).

17. A method according to claim 13, characterized in that said dedicated fields (Cj) associated with the packets (Pj) of a frame are placed in an ordered fashion in the header (OH) of the frame according to the order of the associated packets (Pj) in said frame.

18. A method according to claim 13, characterized in that said dedicated fields (Pj) are of variable size.

19. A method according to claim 13, characterized in that said dedicated fields (Pj) are of fixed size.
